(19) United States
(12) Patent Application Publication
(10) Pub. No.: US 2017/0306911 A1
(43) Pub. Date: Oct. 26, 2017

(54) FUEL PUMP MODULE FOR IMPROVING RADIANT HEAT AND METHOD FOR MANUFACTURING THE SAME

(71) Applicant: COAVIS, Sejong-si (KR)

(72) Inventors: Young Sub JANG, Sejong-si (KR); Suk Min YOON, Sejong-si (KR)

(21) Appl. No.: 15/491,431

(22) Filed: Apr. 19, 2017

(30) Foreign Application Priority Data
Apr. 22, 2016 (KR) 10-2016-0049326

(51) Int. Cl. F02M 59/44; B29C 65/56; B29C 45/14; B29C 65/48; F28F 3/02; B29K 105/00; B29L 31/00

(52) U.S. Cl. CPC F02M 59/44; B29C 65/48; B29C 65/562; F28F 3/02; B29C 45/14467; B29L 2031/7496; F28F 2255/143; B29K 2105/0058

(57) ABSTRACT

Provided are a fuel pump module for improving radiant heat and a method for manufacturing the same, in which when heat generating components included in the fuel pump module are fixed by a potting process of injecting a liquefied resin, a guide is installed first, the liquefied resin is injected, and a heat radiating plate is inserted into the guide to increase a size of the heat radiating plate, thereby increasing heat radiating capability.

### CROSS-REFERENCE TO RELATED APPLICATIONS

This application claims priority under 35 U.S.C. §119 to Korean Patent Application No. 10-2016-0049326, filed on Apr. 22, 2016, in the Korean Intellectual Property Office, the disclosure of which is incorporated herein by reference in its entirety for all purposes.

### TECHNICAL FIELD

The following disclosure relates to a fuel pump module for improving radiant heat and a method for manufacturing the same, and more particularly, to a fuel pump module for improving radiant heat and a method for manufacturing the same, in which when heat generating components included in the fuel pump module are fixed by a potting process of injecting a liquefied resin, a guide is installed first, the liquefied resin is injected, and a heat radiator is inserted into the guide, thereby increasing a size of the heat radiator and improving heat radiating capability.

### BACKGROUND

A fuel tank of a vehicle is provided with a fuel pump module for delivering fuel stored in the fuel tank to an injector of an engine.

The fuel pump module may include a fuel pump, a filter for filtering fuel pumped by the fuel pump to remove impurities, a reservoir cup fixed to the fuel tank and the reservoir cup with the fuel pump and the filter installed therein, a bracket for fixing the fuel pump to the reservoir cup, a flange (or holder cap) for fixing the fuel pump and the reservoir cup to the fuel tank, and the like.

At this time, the flange is provided with electronic components for controlling an operation of the fuel pump. These electronic components generate heat during operation. In order to prevent the above problem, Korean Patent Laid-Open Publication No. 10-2014-0129756 (“Controller Integrated Fuel Pump Module”, published on Nov. 17, 2014, hereinafter referred to as related art) discloses that a heat radiator contacts electronic components generating heat to radiate the heat.

As illustrated in FIG. 1, a flange 10 of a fuel pump module is provided with a housing portion 100 in which various electronic components (heat generator 110) generating heat during operation are installed. At this time, the heat generator 110 generates heat during operation, and therefore a heat radiator 200 needs to be installed to radiate the heat. At this point, in order to fix the heat radiator 200 to the housing portion 100, the heat generator 110 and the heat radiator 200 are positioned in the housing portion 100, and then are fixed to the housing portion 100 by a potting process of injecting a liquefied resin 400.

That is, if the heat generator 110 and the heat radiator 200 are installed in the housing portion 100 and then the liquefied resin (polyurethane, epoxy, silicone, etc.) is injected thereinto and solidified, the heat generator 110 and the heat radiator 200 may be fixedly installed in the housing portion 100. At this point, the larger the size of the heat radiator 200, the higher the heat radiating capability becomes. Conventionally, the heat radiator 200 is installed for the potting process and then the liquefied resin 400 is injected, and therefore the size of the heat radiator 200 cannot but be limited. That is, since there is a need to secure an area for the potting, there is a problem in that the heat radiator 200 over a certain size may not be attached.

Accordingly, there is a need for a technique for increasing the size of the heat radiator to increase the heat radiating capability while fixing the heat generating components by the potting process.

### SUMMARY

An embodiment of the present invention is directed to providing a fuel pump module for improving radiant heat and a method for manufacturing the same, in which electronic components of the fuel pump module are positioned in a housing portion and then a guide is installed to inject a liquefied resin by a potting process and fix electronic components, thereby increasing a size of a heat radiator and improving heat radiating capability.

In one general aspect, a fuel pump module includes: a housing portion 100 having an upper part opened and a heat generator 110 generating heat positioned therein; a heat radiator 200 contacting the heat generator 110 to radiate the heat generated from the heat generator 110; a guide portion 300 forming an insertion space 310 into which a lower part of the heat radiator 200 is inserted; and a potting portion 400 fixing the heat generator 110, the heat radiator 200, and the guide portion 300 by injecting a liquefied resin into the housing portion 100, in which the liquefied resin may not be injected into the insertion space 310 of the guide portion 300.

The heat radiator 200 may include: a heat radiating plate 210 formed over a plurality of heat radiating fins 211; and an insertion portion 220 formed under the heat radiating plate 210 and inserted into the insertion space 310.

The heat radiating plate 210 may have a size corresponding to an area of the housing portion 100.

The heat radiating plate 210 may be coupled to the housing portion 100.

The heat radiating plate 210 and an upper part of the housing portion 100 may be bonded to each other by an adhesive member.

The guide portion 300 may be provided with a coupling protrusion 320 fitted into an inner surface of the housing portion 100 and the housing portion 100 may be provided with a coupling groove 120 into which the coupling protrusion 320 is inserted.

The guide portion 300 may be coupled to the heat generator 110.

In another general aspect, a method for manufacturing a fuel pump module for improving radiant heat includes: installing a guide portion 300 at a position corresponding to a heat generator 110 within a housing portion 100 having the heat generator 110 positioned therein (S100); potting injecting a liquefied resin into the housing portion 100 to fix the heat generator 110 and the guide portion 300 (S200); and coupling the heat radiator 200 to the guide portion (S300), in which the liquefied resin may not be injected into the insertion space 310 of the guide portion 300.

In the installing of the guide portion (S100), a coupling protrusion 320 formed in the guide portion 300 may be fitted into a coupling groove 120 of the housing portion 100.

In the installing of the guide portion (S100), the guide portion 300 may be coupled to the heat generator 110.

In the coupling of the heat radiator (S300), the heat radiator 200 having a size corresponding to an opening of the housing portion 100 may be coupled to the housing portion 100.

In the coupling of the heat radiator (S300), the housing portion 100 and the heat radiating plate 200 may be bonded to each other by an adhesive member.

Other features and aspects will be apparent from the following detailed description, the drawings, and the claims.

### BRIEF DESCRIPTION OF THE DRAWINGS

FIG. 1 is a cross-sectional view of a flange of the conventional fuel pump module.

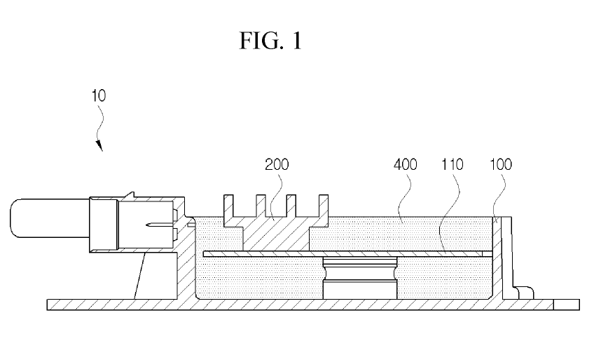

FIG. 2 is a cross-sectional view illustrating an appearance in which a guide portion is installed in a fuel pump module for improving radiant heat according to an exemplary embodiment of the present invention.

FIG. 3 is a top view of the appearance in which the guide portion is installed in the fuel pump module for improving radiant heat according to an exemplary embodiment of the present invention.

FIG. 4 is a cross-sectional view illustrating a potting process in a state where the guide portion is installed in the fuel pump module for improving radiant heat according to an exemplary embodiment of the present invention.

FIG. 5 is a top view of the potting process in the state where the guide portion is installed in the fuel pump module for improving radiant heat according to an exemplary embodiment of the present invention.

FIG. 6 is a cross-sectional view of the fuel pump module for improving radiant heat according to an exemplary embodiment of the present invention.

FIG. 7 is a plan view of the fuel pump module for improving radiant heat according to the exemplary embodiment of the present invention.

FIG. 8 is a flow chart of a method for manufacturing a fuel pump module for improving radiant heat according to an exemplary embodiment of the present invention.

### DETAILED DESCRIPTION OF MAIN ELEMENTS

| | | | |
|---|---|---|---|
| 10: | Flange of fuel pump module | | |
| 100: | Housing portion | 110: | Heat generator |
| 120: | Coupling groove | | |
| 200: | Heat radiator | 210: | Heat radiating plate |
| 211: | Heat radiating fin | 220: | Insertion portion |
| 300: | Guide portion | 310: | Insertion space |
| 320: | Coupling protrusion | | |
| 400: | Potting portion | | |
| S100: | Installing of guide portion | | |
| S200: | Potting | | |
| S300: | Coupling of heat radiator | | |

### Detailed Description of Embodiments

Hereinafter, a technical spirit of the present invention will be described in more detail with reference to the accompanying drawings.

A fuel pump module for improving radiant heat according to an exemplary embodiment of the present invention uses a guide portion to be able to mount a heat radiating plate irrespective of size, thereby improving the radiant heat.

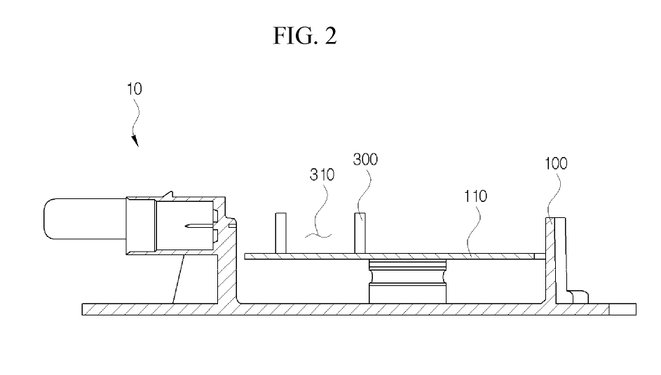

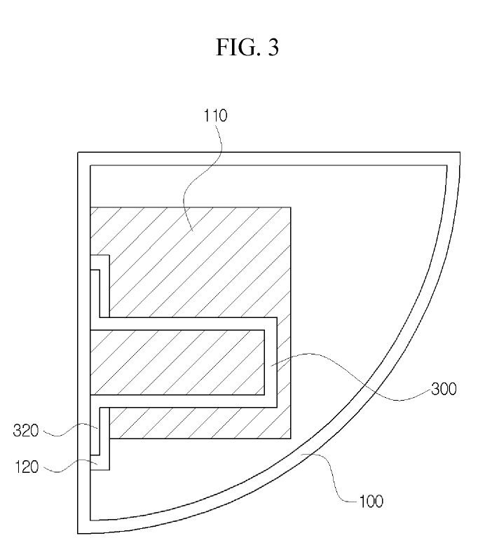

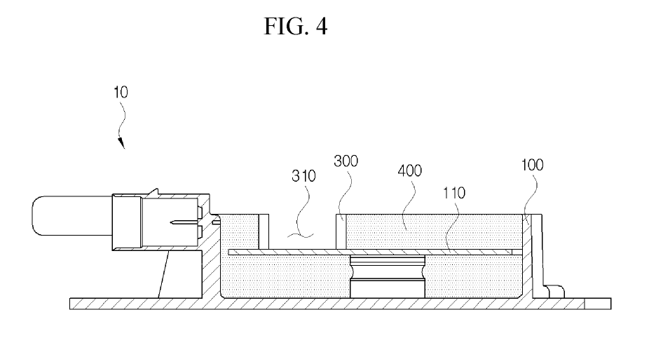

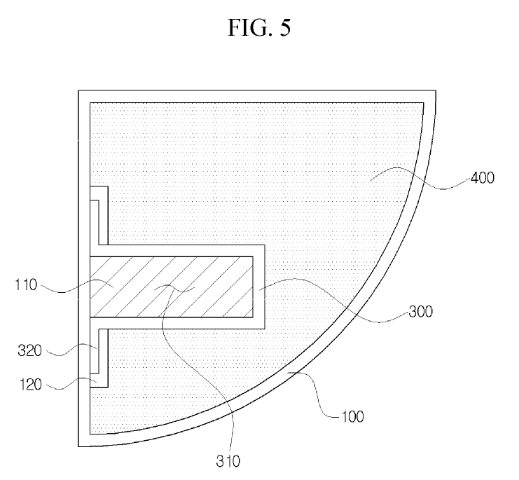

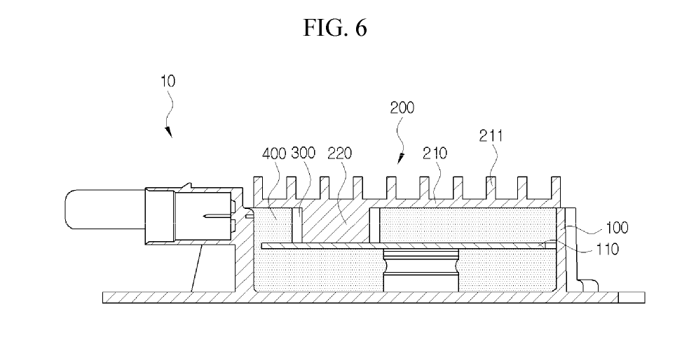

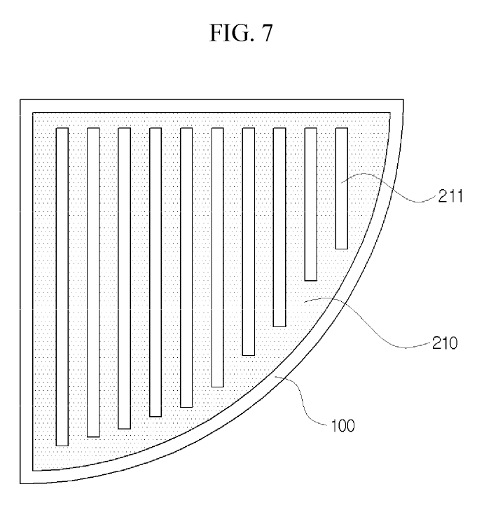

FIG. 2 is a cross-sectional view illustrating an appearance in which a guide portion 300 is installed in a fuel pump module for improving radiant heat according to an exemplary embodiment of the present invention, FIG. 3 is a top view of the appearance in which the guide portion 300 is installed in the fuel pump module for improving radiant heat according to an exemplary embodiment of the present invention, FIG. 4 is a cross-sectional view illustrating a potting process in a state where the guide portion 300 is installed in the fuel pump module for improving radiant heat according to an exemplary embodiment of the present invention, FIG. 5 is a top view of the potting process in the state where the guide portion 300 is installed in the fuel pump module for improving radiant heat according to an exemplary embodiment of the present invention, FIG. 6 is a cross-sectional view of the fuel pump module for improving radiant heat according to an exemplary embodiment of the present invention, and FIG. 7 is a plan view of the fuel pump module for improving radiant heat according to the exemplary embodiment of the present invention.

Referring to FIGS. 2 to 7, in the fuel pump module for improving radiant heat according to the exemplary embodiment of the prevent invention, a flange 10 of the fuel pump module is provided a housing portion 100.

The housing portion 100 has an upper part opened and a heat generator 110 generating heat positioned therein. At this time, the heat generator 110 may be an electronic component generating heat.

The housing portion 100 is provided with a heat radiator 200 contacting the heat generator 110 to radiate the heat generated from the heat generator 110.

The heat radiator 200 is formed of a plate-like heat radiating plate 210, and a plurality of heat radiating fins 211 are provided over the heat radiating plate 210. In addition, an insertion portion 220 partially protruding downward may be provided under the heat radiating plate 210. The insertion portion 220 is fitted into an insertion space 310 of the guide portion 300. At this time, the insertion portion 220 is coupled to be surrounded with the guide portion 300. Further, the insertion portion 220 contacts the heat generator 110 to serve to emit the heat generated from the heat generator 110.

Referring to FIGS. 4 and 5, the housing portion 100 is injected with a liquefied resin in a state where the heat generator 110 and the guide portion 300 are installed and the housing portion 100 is provided with a potting portion 400 of which the remaining part other than an inner part of the guide portion 300 of the housing portion 100 is filled with the liquefied resin. Therefore, the liquefied resin is not injected into the insertion space of the guide portion 300.

That is, the potting portion 400 serves to fix the heat generator 110, the heat radiator 200, and the guide portion 300 while the liquefied resin solidifies at room temperature. At this time, the liquefied resin may be polyurethane, epoxy, silicone, or the like.

Further, the potting portion 400 serves to protect electronic components and circuits from being damaged due to internal vibration, water leak, oil leak, and the like as well as to fix the heat generator 110, the heat radiator 200, and the guide portion 300.

In the fuel pump module for improving radiant heat according to the exemplary embodiment of the present invention, after the housing portion 100 of the flange 10 is injected with the liquefied resin in a state where the heat generator 110 and the guide portion 300 are positioned in the housing portion 100 of the flange 10 and is thus fixed with the heat generator 110 and the guide portion 300, the housing portion 100 is coupled to the heat radiator 200, such that a size of the heat radiator 200 may be various.

At this time, the heat radiating plate 210 may have a size corresponding to an area of the housing portion 100. More specifically, the heat radiating plate 210 is coupled to the guide portion 300 in a state where the liquefied resin is injected after the guide portion 300 is installed in the housing portion 100, and the insertion portion 220 is inserted into the insertion space 310 of the guide portion 300. At this time, the heat radiator 200 may have various-sized heat radiating plates 210 except for the insertion portion 220 to improve the radiant heat.

In addition, the heat radiating plate 210 may be coupled to the housing portion 100. That is, the heat radiating plate 210 and the housing portion 100 may be coupled to each other by an adhesive member, or may be coupled to each other by a coupling means such as a screw.

The guide portion 300 may be coupled to the housing portion 100 or may be coupled to the heat generator 110 not to move when positioned in the housing portion 100.

For example, referring to FIGS. 3 and 5, the guide portion 300 is provided with a coupling protrusion 320 fitted into an inner surface of the housing portion 100, and the housing portion 100 may be provided with a coupling groove 120 into which the coupling protrusion 320 is inserted. The guide portion 300 may be fixed by being fitted into the housing portion 100.

Further, the guide portion 300 and the housing portion 100 may be coupled to each other by screw coupling, in addition to the coupling protrusion 320 and the coupling groove 120. That is, the coupling between the guide portion 300 and the housing portion 100 is not limited to the above-described embodiment.

As another example, the guide portion 300 may be bonded to the heat generator 110 with an adhesive or may be screw-coupled thereto by the screw.

Next, a method for manufacturing a fuel pump module for improving radiant heat according to an exemplary embodiment of the present invention will be described.

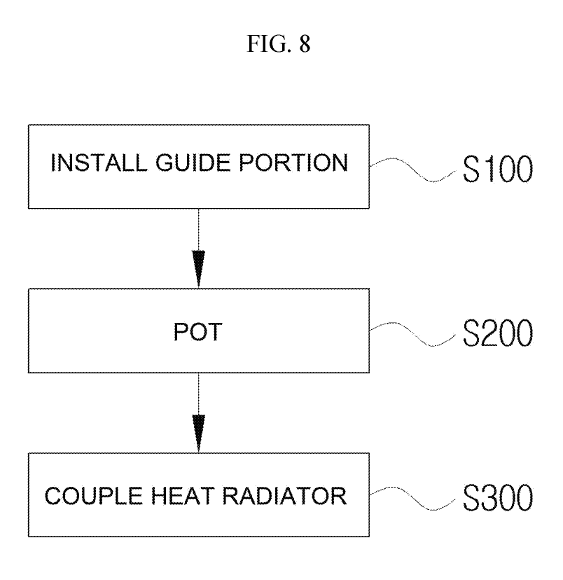

FIG. 8 is a flow chart of a method for manufacturing a fuel pump module for improving radiant heat according to an embodiment of the present invention.

The method for manufacturing a fuel pump module for improving radiant heat according to the exemplary embodiment of the present invention includes installing the guide portion (S100), potting (S200), and coupling the heat radiator (S300).

Referring to FIGS. 2 and 3, in the installing of the guide portion (S100), the guide portion 300 is installed at a position corresponding to the heat generator 110 in the housing portion 100 in which the heat generator 110 is positioned. More specifically, the flange 10 of the fuel pump module is provided with the housing portion 100 of which the upper part is open.

After the heat generator 110 is installed in the housing portion 100, the guide portion 300 is installed to be in contact with the heat generator 110.

At this time, the guide portion 300 may be coupled to the housing portion 100 or may be coupled to the heat generator 110 not to move on the housing portion 100.

For example, the guide portion 300 is provided with the coupling protrusion 320 fitted into the inner surface of the housing portion 100, and the inner surface of the housing portion 100 may be provided with the coupling groove 120 into which the coupling protrusion 320 is inserted. The guide portion 300 may be fixed by being fitted into the housing portion 100.

As another example, the guide portion 300 may also be coupled to the heat generator 110. At this time, the guide portion 300 may also be coupled to the heat generator 110 by the adhesive material, or may also be coupled by the screw coupling. The coupling is not limited thereto, and may be variously made.

Next, referring to FIGS. 4 and 5, in the potting (S200), the guide portion 300 is installed in the housing portion 100 and then the liquefied resin is injected into the housing portion 100 and is solidified at room temperature to fix the heat generator 110 and the guide portion 300 to the housing portion 100. At this time, the liquefied resin is not injected into the insertion space 310 of the guide portion 300. Further, the liquefied resin may be polyurethane, epoxy, silicone, or the like.

Referring to FIGS. 6 and 7, in the coupling of the heat radiator (S300), the heat generator 110 and the guide portion 300 are fixed to the housing portion 100 by the potting process, and then the insertion portion 220 of the heat radiator 200 is inserted into the insertion space 310 of the guide portion 300 and coupled thereto.

At this time, the heat radiator 200 includes the plate-like heat radiating plate 210 and the upper part of the heat radiating plate 210 is provided with the plurality of heat radiating fins 211 and the lower part of the heat radiating plate 210 may be provided with the insertion portion 220 inserted into the insertion space 310 of the guide portion 300. Further, the insertion portion 220 of the heat radiating plate 200 is formed to be in contact with the heat generator 110.

The coupling of the heat radiator (S300) includes coupling the heat radiating plate 210 having a size corresponding to an opening of the housing portion 100 to the housing portion 100. That is, to improve the radiant heat, the heat radiator 200 may be formed so that the size of the heat radiating plate 210 except for the insertion portion 220 is equal to the area of the housing portion 100. At this point, the heat radiating plate 210 may also be coupled to the upper part of the housing portion 100 by the adhesive member to be more firmly coupled to the housing portion 100 or may also be coupled to the housing portion 100 by the screw coupling.

The present invention relates to a fuel pump module for improving radiant heat and a method for manufacturing the same, in which the electronic components of the fuel pump module are positioned in the housing portion and then the guide is installed to inject the liquefied resin by the potting process and fix the electronic components, thereby increasing the size of the heat radiator and thereby improving heat radiating capability.

As the application target of the fuel pump module for improving radiant heat and the method for manufacturing the same according to the exemplary embodiment of the present invention, the fuel pump module for motor vehicle has been described. However, the fuel pump module for improving radiant heat and the method for manufacturing the same according to the exemplary embodiment of the present invention may be variously applied to objects in which the heat radiator is installed by the potting process, and therefore, the present invention is not limited to the fuel pump module.

Further, the present invention is not limited to the above-mentioned embodiments but may be variously applied, and may be variously modified without departing from the gist of the present invention claimed in the following claims.

What is claimed is:

1. A fuel pump module, comprising:
a housing portion having an upper part opened and a heat generator generating heat positioned therein;
a heat radiator contacting the heat generator to radiate the heat generated from the heat generator;
a guide portion forming an insertion space into which a lower part of the heat radiator is inserted; and
a potting portion fixing the heat generator, the heat radiator, and the guide portion by injecting a liquefied resin into the housing portion,
wherein the liquefied resin is not injected into the insertion space of the guide portion.

2. The fuel pump module of claim 1, wherein the heat radiator includes:
a heat radiating plate formed over a plurality of heat radiating fins; and
an insertion portion formed under the heat radiating plate and inserted into the insertion space.

3. The fuel pump module of claim 2, wherein the heat radiating plate has a size corresponding to an area of the housing portion.

4. The fuel pump module of claim 2, wherein the heat radiating plate is coupled to the housing portion.

5. The fuel pump module of claim 4, wherein the heat radiating plate and an upper part of the housing portion are bonded to each other by an adhesive member.

6. The fuel pump module of claim 1, wherein the guide portion is provided with a coupling protrusion fitted into an inner surface of the housing portion, and
the housing portion is provided with a coupling groove into which the coupling protrusion is inserted.

7. The fuel pump module of claim 1, wherein the guide portion is coupled to the heat generator.

8. A method for manufacturing a fuel pump module for improving radiant heat, comprising:
installing a guide portion at a position corresponding to a heat generator within a housing portion having the heat generator positioned therein;
injecting a liquefied resin into the housing portion to fix the heat generator and the guide portion (S200); and
coupling a heat radiator to the guide portion,
wherein the liquefied resin is not injected into an insertion space of the guide portion.

9. The method of claim 8, wherein in the installing of the guide portion, a coupling protrusion formed in the guide portion is fitted into a coupling groove of the housing portion.

10. The method of claim 8, wherein in the installing of the guide portion, the guide portion is coupled to the heat generator.

11. The method of claim 8, wherein in the coupling of the heat radiator, the heat radiator having a size corresponding to an opening of the housing portion is coupled to the housing portion.

12. The method of claim 11, wherein in the coupling of the heat radiator, the housing portion and the heat radiating plate are bonded to each other by an adhesive member.
